(19) United States
(12) Patent Application Publication
(10) Pub. No.: US 2011/0073071 A1
(43) Pub. Date: Mar. 31, 2011

(54) Internally Nested Variable-Area Fuel Nozzle

(75) Inventor: David S. Smith, Holland, MI (US)

(73) Assignee: Woodward Governor Company, Fort Collins, CO (US)

(21) Appl. No.: 12/569,996

(22) Filed: Sep. 30, 2009

(51) Int. Cl. F02M 37/00

(52) U.S. Cl. 123/445

(57) ABSTRACT

A nested fuel injector that includes an injector housing having a bore longitudinally therethrough, and a pintle assembled to the housing and positioned substantially within the bore. The pintle has a head located at an end of a cylindrical portion, wherein the head is seated in one end of the bore, and the seating of the head defines a variable-area exit orifice. A wave spring is assembled onto the pintle and configured to urge the pintle into the seating position. The bore is configured for the passage of a pressurized flow of fuel. The fuel pressure urges the pintle head away from the exit orifice to permit the pressurized fuel to flow from the bore out through the exit orifice.

### FIELD OF THE INVENTION

This invention generally relates to fuel delivery systems, and, more particularly, to fuel injectors for delivering fuel to the combustion chambers of combustion engines.

### BACKGROUND OF THE INVENTION

Variable-area fuel injectors have been used in many applications relating to air-breathing propulsion systems, including, for example, in ramjets, scramjets, and in gas turbine engines such as those used in aviation. Ramjets, scramjets, and gas turbine engines typically include a section for compressing inlet air, a combustion section for combusting the compressed air with fuel, and an expansion section where the energy from the hot gas produced by combustion of the fuel is converted into mechanical energy. The exhaust gas from the expansion section may be used to achieve thrust or as a source of heat and energy.

Generally, some type of fuel injector is used in the combustion section for spraying a flow of fuel droplets or atomized fuel into the compressed air to facilitate combustion. In some applications of air-breathing propulsion systems including ramjets, scramjets, and particularly in gas turbine engines, which must run at variable speeds, variable-area fuel injectors have been used because they provide an inexpensive method to inject fuel into a combustor, while also metering the fuel flow without the need for an additional metering valve.

Typically, the fuel flow rate is controlled by the combination of a spring, the fuel pressure, and an annular area, which is increasingly exposed as the fuel pressure is increased. This is unlike the operation of pressure-swirl atomizers where the pressure-flow characteristics are static, and are determined solely by injector geometry and injection pressure. Generally, variable-area fuel injectors provide good atomization over a much wider range of flow rates than do most pressure-swirl atomizers. Additionally, with variable-area fuel injectors, the fuel pressure drop is taken at the fuel injection location, thus providing better atomization in some flow conditions than typical pressure-swirl and plain-orifice atomizers.

With the increasing cost and complexity of new engine designs, there may be instances when a decrease in the size of fuel nozzles is desired due to space limitations within the engine and/or combustion region.

It would therefore be desirable to have a variable-area fuel nozzle that is more compact, lighter in weight, and potentially less costly, than conventional variable-area fuel nozzles. Embodiments of the invention provides such a fuel nozzle. These and other advantages of the invention, as well as additional inventive features, will be apparent from the description of the invention provided herein.

### BRIEF SUMMARY OF THE INVENTION

In one aspect, embodiments of the invention provide a nested fuel injector that includes an injector housing having a bore longitudinally therethrough, and a pintle assembled to the housing and positioned substantially within the bore. The pintle has a head located at an end of a cylindrical portion, wherein the head is seated in one end of the bore, and the seating of the head defines a variable-area exit orifice. A wave spring is assembled onto the pintle and configured to urge the pintle into the seating position. The bore is configured for the passage of a pressurized flow of fuel. The fuel pressure urges the pintle head away from the exit orifice to permit the pressurized fuel to flow from the bore out through the exit orifice

In another aspect, embodiments of the invention provide a fuel injector that includes a body that includes a cylindrical threaded portion, and a variable-area injector arrangement having a pintle, a wave spring, and a retaining plate operatively connected to the injector body. The wave spring urges a head of the pintle to seal against a variable-area exit orifice of the body. The bore is configured such that a flow of pressurized fuel within the bore of the body causes the head of the pintle to move out of contact with the variable-area exit orifice. This provides a passage for fuel through the variable-area exit orifice about the head of the pintle, such that the flow rate of fuel through the variable-area exit orifice increases with the fuel pressure. Furthermore, the retaining plate is configured to place a pre-load on the wave spring.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a plan view of a fuel injector according to an embodiment of the invention;

FIG. 2 is a cross-sectional view of the fuel injector of FIG. 1;

FIG. 3 is an end view of a retaining plate, according to an embodiment of the invention;

FIG. 4 is a cross-sectional view of a fuel injector according to an embodiment of the invention different from the embodiment in FIG. 2;

FIG. 5 is a cross-sectional view of a fuel injector according to yet another embodiment of the invention;

FIGS. 6 and 7 are plan views of a fuel injector, according to another embodiment of the invention; and

FIG. 8 is a cross-sectional view of the fuel injector shown in FIGS. 6 and 7.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

With respect to variable-area fuel nozzles, generally the largest dimension of the device is along the longitudinal axis of the nozzle. Therefore, to significantly reduce the size of the fuel nozzle, it is most productive to reduce the fuel nozzle's axial length. Additionally, to increase engine performance and reduce engine cost, reductions in weight and complexity are highly desired.

One of the major contributors to the axial length of conventional variable-area fuel nozzles is the metering spring. Typically, the metering spring is comprised of a coil spring. To achieve the desired stroke and loading, it is often necessary to have a metering spring of a relatively long length. Additionally, a retaining assembly may be required to give the spring a positive stop.

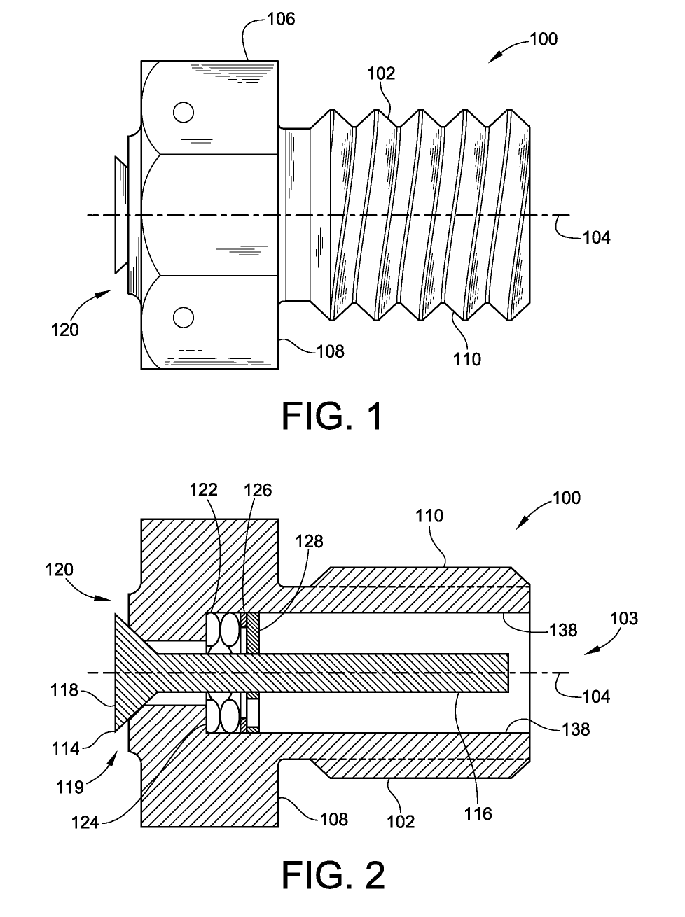

Embodiments of the present invention address the aforementioned issue of fuel injector size and the effects associated therewith as related to fuel injection in air-breathing propulsion systems, and particularly in ramjets, scramjets, and gas turbine engines, by providing an exemplary compact fuel injector design, which is illustrated in FIG. 1. One way to achieve such compactness in fuel injector design is to reduce the axial length of the fuel injector by replacing the conventional pintle spring with a more compact component. When such a change is accompanied by a corresponding reduction in the axial length of the pintle, a substantial reduction in the axial length of the fuel injector may be realized.

According to an embodiment of the invention, a variable-area injector 100, as illustrated in FIGS. 1 and 2, has a body, or housing, 102 having a bore or opening 103 along a longitudinal axis 104 of the injector 100, and which includes a hexagonal outer surface 106, a sealing surface 108, and a threaded portion 110. In alternate embodiments, the outer surface 106 may be square, lobe-shaped, or of some other suitable shape that permits installation of the body, for example into the combustion chamber of a ramjet, scramjet or gas turbine engine, using some type of readily available wrench or similar tool. The variable-area injector 100 further includes a pintle 114, which, in this embodiment, has a small-diameter cylindrical portion 116 and a conical head 118 at one end of the cylindrical portion 116. In an embodiment of the invention, the cylindrical portion 116 of the pintle 114 is threaded. It is also contemplated that the pintle head could have a shape other than the conical shape shown in FIG. 2. For example, a spherical-shaped head could be used according to an embodiment of the invention. With the appropriate changes to the exit orifice 119, a variety of pintle head shapes could be used.

During assembly of the variable-area injector 100, the pintle 114 will typically be inserted into the longitudinal opening 103 in the body 102. Typically, the cylindrical portion 116 of the pintle is inserted initially at an end 120 of the body 102, such that when the pintle 114 is fully inserted, the conical head 118 is seated in an exit orifice 119 in the longitudinal opening 103 at the second end 120 of the body 102. A wave spring 122 is assembled into the opening 103 over the cylindrical portion 116 of the pintle 114 until it abuts a substantially vertical portion 124 of the wall of the opening 103.

A wave spring is coiled flat wire with waves added to give the wire a spring effect. Wave springs may, in certain applications, provide the same force as a coil spring of larger size. This not only offers the potential for space savings, but also for smaller assemblies that use less materials, and, therefore, reduce production costs. As will be explained more fully below, a wave spring can be used to exert a force, or pre-load, on a part or assembly to keep selected components in relatively constant contact. The selected components will remain in contact until the application of a counteracting force greater than that of the pre-load separates these selected components.

As shown in FIGS. 1 and 2, the wave spring 122 has an axial length, which is substantially less than the axial length of an equivalent coil spring. In some embodiments, one or more shims 126 may be assembled over the cylindrical portion 116 of the pintle 114 up to the wave spring 122. The wave spring 122 and optional shim(s) 126 are held in place by a retaining plate 128. The retaining plate 128 can be attached to the pintle 114 by welding, brazing, or by any other suitable method. For example, the cylindrical portion 116 of the pintle 114 could be threaded such that the retaining plate 128 could be threaded onto the pintle 114 to hold the wave spring 122 and shim(s) 126 in place. After the retaining plate 128 is assembled onto the pintle 114, the threads on the cylindrical portion 116 can be intentionally damaged so that the position of the retaining plate 128 cannot be changed, thus maintaining the same pre-load on the wave spring 122. In an alternate embodiment, a lock nut (not shown) may be assembled onto the pintle 114 to fix the position of the retaining plate 128.

In operation, pressurized fuel is introduced into the opening 103. In an embodiment of the invention, the retaining plate places a pre-load on the wave spring 122, which urges the pintle 114 in a manner that keeps the conical head 118 seated in the exit orifice 119 when no fuel is flowing. The force of the pressurized fuel flow against the conical head 118 causes the pintle 114 to axially translate in the direction of the flow and, in turn, causes the conical head 118 to lift out of the exit orifice 119. This causes the retaining plate 128 to axially translate in the same direction and further compress the pre-loaded wave spring 122. One or more openings in the retaining plate 128 allow the fuel to flow through the opening 103 out through the exit orifice 119. The exit orifice 119 is a variable-area orifice, in that as the fuel pressure increases, the wave spring 122 is increasingly compressed and the conical head 118 moves farther away from the exit orifice 119. As the distance of the conical head 118 from the exit orifice 119 increases, the exit orifice area increases, thus allowing for a resulting increase in the rate of fuel flow through the fuel injector 100. The use of the wave spring 122, instead of the coil spring used in conventional fuel injectors allows the pintle 114 to be shortened substantially, such that all of the components of the fuel injector 100 are substantially contained within the injector housing 102.

In some embodiments, position of the retaining plate 128 may be fixed. For example, the threads on the cylindrical portion 116 of the pintle 114 could end at a certain distance from wave spring 122 such that the retaining plate 128 does not abut the wave spring 122. In such an instance, one or more shims 126 could be assembled to the pintle 114 such that the shim(s) abut the wave spring 122 and the retaining plate 128. Additional shims 126 could be added to such an assembly when an increase in the pre-load is desired. In an alternate embodiment, the cylindrical portion 116 of the pintle may have a step feature which acts as a stop for the retaining plate 128. The retaining plate 128 could be welded or brazed to this step feature, and one or more shims 126 would be assembled between the wave spring 122 and retaining plate 128 to control the amount of pre-load on the wave spring 122.

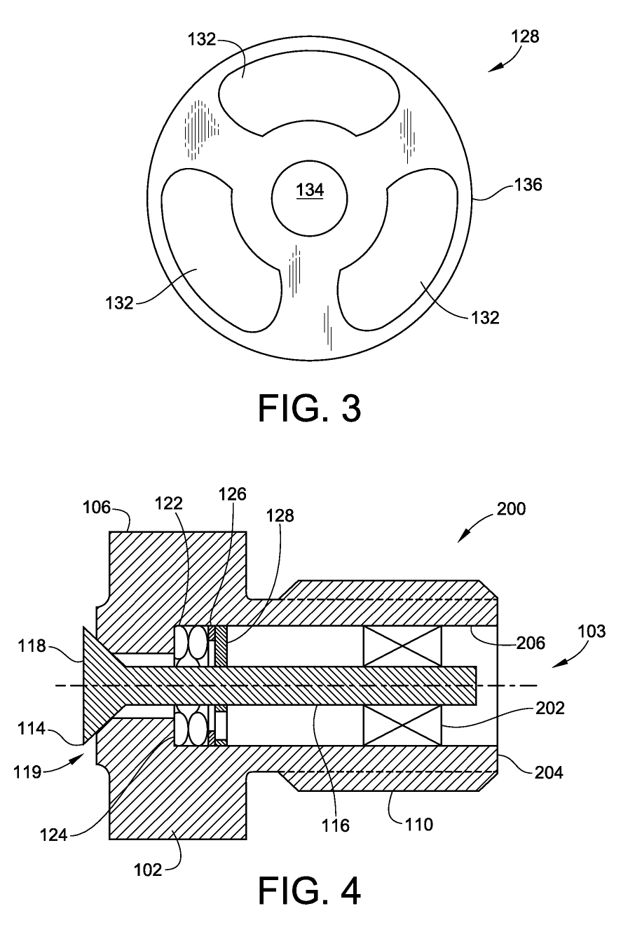

FIG. 3 shows an exemplary embodiment of the retaining plate 128 including three openings 132. However, alternate embodiments of the retaining plate may greater or fewer than three openings. The retaining plate 128 of FIG. 2 also includes a central opening 134 configured to accept the pintle 114 during assembly. In some embodiments, the central opening 134 may be threaded to facilitate assembly to the pintle 114. During operation, the three openings 132 provide a path for the flow of pressurized fuel through the fuel injector 100. The diameter of the retaining plate 128 is such that an outer perimeter 136 of the perimeter 128 is in close proximity to a wall 138 (shown in FIG. 2) of the injector bore 103.

In the embodiment illustrated in FIG. 4, a fuel swirler 202 is assembled to a fuel injector 200 over the pintle 114 into the opening 103. The fuel injector 200 includes the injector body 102 with hexagonal portion 106 and threaded portion 110. In the embodiment of FIG. 4, the fuel swirler 202 is assembled into the opening 103 after (i.e., upstream from) the wave spring 122, any optional shims 126, and the retaining plate 128 such that the fuel swirler 202 is positioned closer to an end 204 of the body 102 than to the substantially vertical portion 124 of the wall of the opening 103. As in the previous embodiment, the wave spring 122 biases the conical head 118 of the pintle 114 into the exit orifice 119, cutting off the flow of fuel from the fuel injector 200. In an embodiment of the invention, both the wall of the opening 103 and an outer surface of the fuel swirler 202 are threaded to facilitate assembly. In such an embodiment, the cylindrical portion 116 of the pintle 114 and the retaining plate 128 could also be threaded to facilitate assembly. However, other embodiments of the invention include equally suitable means for attaching the retaining plate 128 to the pintle 114, and for attaching the fuel swirler 202 to the opening 103 in the body 102 including, but not limited to, press-fit, welding and brazing may be used.

In at least one embodiment, the fuel swirler 202 has a generally cylindrical body (not shown) which has one or more vanes (not shown) that spiral around the outer surface of the cylindrical body. In some embodiments, the vanes are integral (i.e., not separable) with the cylindrical body, though it is contemplated that a fuel swirler 202 having a cylindrical body with non-integral vanes could be used. Typically, in this embodiment, each of the one or more vanes has a raised portion (not shown) configured to engage the wall 206 of the fuel injector bore 103 when the fuel swirler 202 is assembled to the body 102. The swirler 202 geometry can also include other designs. For examples, the vanes could be helical or straight, and the swirler 202 could be a “plug” with various orifices having angled geometries, or slots oriented to induce swirl into the fuel flow.

In operation, when pressurized fuel flows into the fuel injector 200 and around the fuel swirler 202 towards the exit orifice 119, the fuel begins to swirl due to the spiraling shape of the one or more vanes. As a result of this swirling action, non-uniformities, such as those caused by upstream wakes, in the fuel flow are reduced or eliminated. This swirling action, especially at high flow rates, also tends to thin out the liquid sheet as it flows through the exit orifice 134, thus improving atomization of the fuel, which, in turn, improves combustion, leading to increased engine efficiency and less pollution. The pressurized fuel flows through openings 132 (shown in FIG. 3) in the retaining plate 128 and counteracts the preload placed on the pintle 114 due to biasing by the wave spring 122. When the fuel pressure exceeds a threshold level, the conical head 118 moves away from the exit orifice 119, thus allowing fuel to flow from the fuel injector 200.

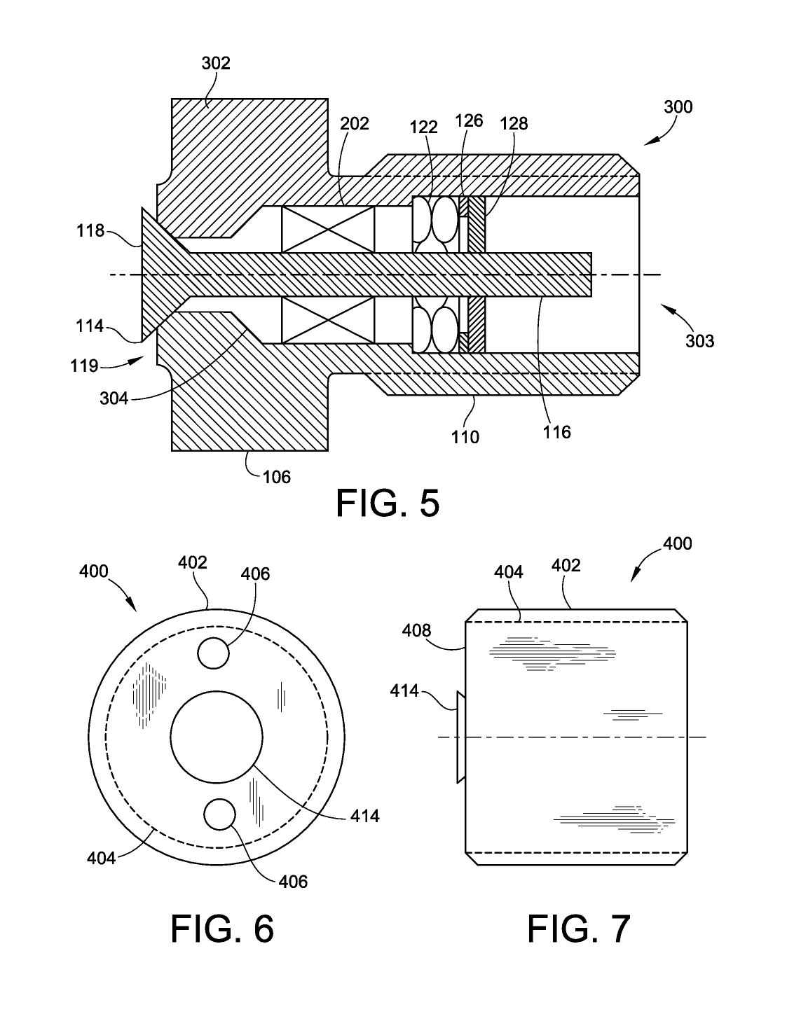

FIG. 5 shows an alternate embodiment of the fuel injector 300 in which the fuel swirler 202 is located in a bore 303 downstream of the wave spring 122, the retaining plate 128, and any optional shims 126. The fuel injector 300 includes an injector body, or housing 302 with hexagonal portion 106 and threaded portion 110. The wave spring 122 urges the conical head 118 of the pintle 114 to seat in the exit orifice 119. During assembly, the pintle 114 is assembled into the bore 303 of the injector body 302, and the fuel swirler 202 is assembled onto the pintle 114, within the bore 303. In one embodiment, an angled portion 304 of the bore wall serves as a physical stop for the fuel swirler 202, though, as can be seen from the embodiment of FIG. 5, the fuel swirler 202 does not have to abut the angled portion 304. The fuel swirler 202 may be threaded into the bore 303, though other suitable means of attachment, including, but not limited to, press-fit, brazing and welding, may be used as well. The wave spring 122 and retaining plate 128, along with any optional shims 126, are assembled onto the cylindrical portion 116 of the pintle 114, within the bore 303. The retaining plate 128 can be assembled to the pintle 114, using threaded means or other suitable attachment means such as brazing or welding.

In operation, pressurized fuel enters the fuel injector 300 via bore 303 flowing through the openings 132 (shown in FIG. 3) in the retaining plate 128. The pressurized fuel then flows through the fuel swirler 202, creating a swirling action in the fuel flow that aids in the uniformity of the fuel spray from the fuel injector 300. When the fuel pressure on the conical head 118 exceeds a threshold level, the conical head 118 moves away from the exit orifice 119, thus allowing fuel to flow from the fuel injector 300.

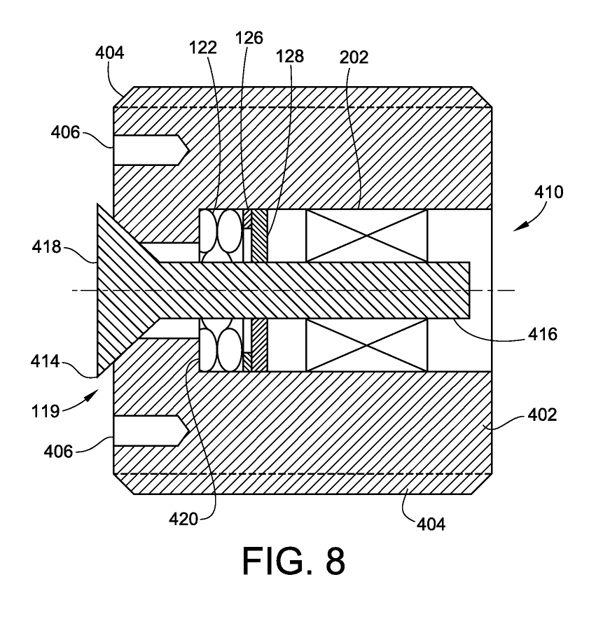

FIGS. 6 and 7 are plan views of an exemplary embodiment of a fuel injector 400 having a body, or housing, 402, which omits the hexagonal portion shown in previous embodiments, instead having a cylindrical threaded portion 404. As a result, this embodiment has the potential to be even more compact than previous embodiments. As can be seen in FIG. 8, the length of both the body 402 and a pintle 414, specifically a cylindrical portion 416 of the pintle 414, can be made shorter than in embodiments where the body includes a hexagonal and a threaded portion. As shown in FIG. 6, the body 402 further includes two holes 406 drilled, or formed, into an end, or axial face, 408 of the body 402, wherein the two hole 406 are configured to accommodate a spanner wrench (not shown) or similar tool. The spanner wrench is inserted into holes 406 to assemble the fuel injector 400 into a threaded opening in the combustion chamber (not shown) of an engine (not shown).

FIG. 8 is a cross-sectional view of the fuel injector 400 shown in FIGS. 6 and 7. The pintle 414 has a conical head 418 at one end of the cylindrical portion 416, and is assembled from the end 408 into a bore 410 of the body 402. The conical head 418 is seated in the exit orifice 119. The wave spring 122 is assembled onto the cylindrical portion 416 of the pintle 414 in the bore 410 and abuts a substantially vertical portion 420 of the wall of the bore 410. One or more optional shims 126 and the retaining plate 128 are then assembled onto the cylindrical portion 416 of the pintle 414 inside the bore 410. The fuel swirler 202 is then assembled into the bore 410 upstream of the wave spring 122 and retaining plate 128. The cylindrical portion 416 of the pintle 414 and the retaining plate 128 may be threaded to facilitate assembly, or other suitable means such as brazing, press-fit, or welding may be used to assemble these components. Similarly, the wall of the bore 410 and an outer surface of the fuel swirler 202 may be threaded to facilitate assembly, or the fuel swirler 202 may be press-fit, brazed or welded into the bore 410. In alternate embodiments of the invention, the fuel swirler 202 is assembled into the bore 410 downstream of the wave spring 122, shims 126, and retaining plate 128. In yet another embodiment of the invention, the fuel injector 400 does not include a fuel swirler 202.

In operation, pressurized fuel enters the bore 410 flowing through the fuel swirler 202, which creates a swirling action in the fuel flow. The swirling action reduces or eliminates wakes, and other non-uniformities, in the fuel flow. The pressurized fuel then flows through openings 132 (shown in FIG. 3) in the retaining plate 128. When the fuel pressure on the conical head 418 exceeds some threshold level, it overcomes the force placed on the pintle 414 by the pre-loaded wave spring 122. This lifts the conical head 418 away from the exit orifice 119, allowing fuel to flow from the fuel injector 400 into the combustion chamber (not shown).

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A nested fuel injector comprising:
an injector housing having a bore longitudinally therethrough;
a pintle assembled to the housing and positioned substantially within the bore, the pintle having a head located at an end of a cylindrical portion, wherein the head is seated in one end of the bore, the seating of the head defining a variable-area exit orifice; and
a wave spring assembled onto the pintle and configured to urge the pintle into the seating position;
wherein the bore is configured for the passage of a pressurized flow of fuel, and wherein the fuel pressure urges the pintle head away from the variable-area exit orifice to permit the pressurized fuel to flow from the bore out through the variable-area exit orifice.

2. The nested fuel injector of claim 1, further comprising a fuel swirler operatively attached to a wall of the bore.

3. The nested fuel injector of claim 2, wherein the fuel swirler is located upstream of the wave spring.

4. The nested fuel injector of claim 2, wherein the fuel swirler is located downstream of the wave spring.

5. The nested fuel injector of claim 1, further comprising a retaining plate operatively attached to the pintle and abutting the wave spring.

6. The nested fuel injector of claim 5, further comprising one or more shims assembled onto the pintle and disposed between the wave spring and the retaining plate.

7. The nested fuel injector of claim 1, wherein the pintle includes a conical head at the end of the cylindrical portion.

8. The nested fuel injector of claim 1, wherein the amount of pressure needed to move the head of the pintle away from the variable-area exit orifice is determined by a pre-load on the wave spring.

9. The nested fuel injector of claim 8, wherein the pre-load is placed on the wave spring by a retaining plate.

10. The nested fuel injector of claim 1, wherein the injector housing comprises a hexagonal portion and a threaded portion.

11. The nested fuel injector of claim 10, wherein the threaded portion permits assembly of the nested fuel injector into a threaded opening for a combustion chamber, and wherein the hexagonal portion facilitates the use of a wrench to perform the assembly.

12. The nested fuel injector of claim 1, wherein the injector housing comprises a threaded portion, and an axial face having at least two holes therein.

13. The nested fuel injector of claim 12, wherein the threaded portion permits assembly of the nested fuel injector into a threaded opening for a combustion chamber, and the at least two holes facilitates the use of a spanner wrench to perform the assembly.

14. A fuel injector comprising:
a body that includes a bore therein, and further includes a cylindrical threaded portion;
a variable-area injector arrangement having a pintle, a wave spring, and a retaining plate operatively connected to the injector body such that the wave spring urges a head of the pintle to seal against a variable-area exit orifice of the body, and such that a flow of pressurized fuel within the bore of the body causes the head of the pintle to move out of contact with the variable-area exit orifice, providing a passage for fuel through the variable-area exit orifice about the head of the pintle, wherein the flow rate of fuel through the variable-area exit orifice increases with the fuel pressure; and
wherein the retaining plate is configured to place a pre-load on the wave spring.

15. The fuel injector of claim 14, further comprising one or more shims disposed between the wave spring and the retaining plate.

16. The fuel injector of claim 14, wherein the head of the pintle comprises a conically-shaped head of the pintle.

17. The fuel injector of claim 14, wherein the body includes an axial face having at least two holes therein, the at least two holes configured to facilitate the use of a spanner wrench for threading the fuel injector into a combustion chamber of an engine.

18. The fuel injector of claim 14, wherein the body includes a hexagonal portion to facilitate the use of a wrench for threading the fuel injector into a combustion chamber of an engine.

19. The fuel injector of claim 14, further comprising a fuel swirler operatively attached to a wall of the bore.

20. The fuel injector of claim 19, wherein the fuel swirler is operatively attached to the wall of the bore by one of brazing, press-fit, welding, and threaded assembly.

21. The fuel injector of claim 19, wherein the fuel swirler is located downstream of the wave spring and retaining plate.

22. The fuel injector of claim 19, wherein the fuel swirler is located upstream of the wave spring and retaining plate.

23. The fuel injector of claim 14, wherein the amount of pressure needed to move the head of the pintle away from the variable-area exit orifice is determined by the pre-load on the wave spring.
